(19) United States
(12) Patent Application Publication
(10) Pub. No.: US 2013/0100139 A1
(43) Pub. Date: Apr. 25, 2013

(54) SYSTEM AND METHOD OF SERIAL VISUAL CONTENT PRESENTATION

(71) Applicants: Sagi Schliesser, Holon (IL); Oran Kushnir, Ramat-HaSharon (IL)

(72) Inventors: Sagi Schliesser, Holon (IL); Oran Kushnir, Ramat-HaSharon (IL)

(73) Assignee: Cognitive Media Innovations (Israel) Ltd., Holon (IL)

(21) Appl. No.: 13/704,633

(22) PCT Filed: Jun. 28, 2011
(86) PCT No.: PCT/IL11/00513

§ 371 Date: Dec. 17, 2012

Related U.S. Application Data
(60) Provisional application No. 61/361,444, filed on Jul. 5, 2010.
(60) Provisional application No. 61/384,350, filed on Sep. 20, 2010.

(51) Int. Cl. G06T 11/00

(52) U.S. Cl. CPC G06T 11/00
USPC 345/467

(57) ABSTRACT

A system of presenting textual content over a display area of a user device. The system enabling receiving text segments from a textual content, identifying relative location of each text segment in relation to the textual content, and displaying the text segments and an indication relating to the relative location of the displayed text segment over the display area. The indication is presented over the display area substantially simultaneously to the displaying of the text segment associated therewith. The system may further enable receiving and analyzing personal data relating to the user and adapting the serial visual presentation of the text segments according to the analysis of the personal data.

### FIELD AND BACKGROUND OF THE PRESENT INVENTION

The present invention generally relates to the field of content presentation and more particularly to Rapid Serial Visual Presentation (RSVP) of content.

RSVP is a technology that allows presenting text for reading over limited display areas of devices such as mobile phones, PDAs, and the like and it is also used as an aid tool for aiding readers of poor eyesight or readers who have reading difficulties.

RSVP usually allows dividing a text into segments, where each segment includes a predefined limited number of words (such as between 1-4 words) to allow reading a substantially long text over the limited display area, allowing word size to be large enough for comfortable reading. In RSVP the segments are rapidly and successively presented over the display area, where each segment is allocated with a predefined presentation period.

During the last years, few developments have been made to facilitate the usage of RSVP. For example, the master thesis of Gustav Öquist, Adaptive Rapid Serial Visual Presentation, Language Engineering Programme, Department of Linguistics, Uppsala University, published in 2001, which is herein incorporated by reference in its entirety, discusses methods for adapting exposure time of RSVP text segments according to characteristics of the text. According to Oquist, adaptation of the exposure period to textual characteristics can improve reading speed in cases in which the text for reading is relatively short.

Another example is described in International patent application Publication No. WO0237256 (A1) by GOLDSTEIN MIKAEL et al., filed on 11 Jun., 2000, which is incorporated by reference herein in its entirety, teaches a system, method and computer readable medium for providing enhanced computer-aided reading. A rapid serial visual presentation (RSVP) based text file includes data segments having text and related code portions. The code portions at least code the exposure time of the text portion and the duration of the blank window inserted after completion of a sentence. The exposure time of a text portion is dependent on a plurality of text characteristics. The duration of a blank window is dependent on text reading index. When a computer-based reading device reads the text portion and corresponding code portions, a display device displays the text portion in response to the code portions. Segment exposure time and duration of blank window is scaled to fit a variable mean reading speed.

### SUMMARY OF THE PRESENT INVENTION

According to some embodiments of the present invention, there is provided a system of presenting textual content over a display area of at least one user device. The system comprises an analysis module which receives a plurality of text segments of a textual content and identifies relative location of each text segment in the textual content, and a serial visual presentation module which consecutively displays the plurality of text segments over the display area each substantially simultaneously with at least one indication relating to a respective relative location.

Optionally, the indication is of the relative location of each of the displayed text segments.

Optionally, the analysis module calculates a remaining reading time estimation for each text segment, which is indicated by the serial visual presentation module at the display area.

Additionally or alternatively, the analysis module performs a content analysis of the textual content by identifying a complexity level of each word in the textual content, where the serial visual presentation module adapts serial visual presentation of the textual content, according to the content analysis.

Additionally or alternatively, the analysis module performs an environmental analysis by receiving environmental data relating to the at least one user, where the serial visual presentation module adapts serial visual presentation of the textual content, according to the environmental analysis. The analysis module optionally retrieves the environmental data from at least one sensor, configured to sense environmental conditions of the at least one user.

Additionally or alternatively, the analysis module performs a contextual analysis of the textual content, by identifying a type of the textual content, where the serial visual presentation module adapts serial visual presentation of the textual content, according to the contextual analysis.

Optionally, the system further comprises a personalization module, operatively associated with the serial visual presentation module. The personalization module identifies reading pace of the at least one user, and the serial visual presentation module adapts serial visual presentation of the textual content according to the identified reading pace. The personalization module optionally monitors and stores information relating to reading habits of the at least one user for a predefined period for determining an average reading pace of the at least one user.

Optionally, the system further comprises a navigation module associated with a storage unit. The navigation module is configured to allow a user to navigate through previously displayed text segments by using the identified relative locations and by storing and retrieving of previously displayed text segments from the storage unit.

Optionally, the system further comprises a statistical module, operatively associated with the analysis module and performs a statistical analysis of reading patterns of a plurality of users, where the serial visual presentation module adapts serial visual presentation of the textual content according to the statistical analysis.

Optionally, the system further comprises a visuals module, operatively associated with the serial visual presentation module. The visuals module associates words in the text segments with visual effects, where the serial visual presentation module presents the associated visual effect upon displaying of a respective text segment comprising a word associated with the visual effect.

The analysis module and the serial visual presentation module are, optionally, operated by a user device, which is a handheld device.

Optionally, the analysis module retrieves additional data from an external source relating to activity of the user and analyzes the data, where the serial visual presentation module adapts serial visual presentation of the text segments according to the activity of the user. The additional data optionally comprises biometric parameters relating to the user activity.

The analysis module and the serial visual presentation module are, optionally, installed in a designated gadget device having a display area, where the serial visual presentation is adapted to functionality of the gadget.

Optionally, the analysis module enables translating each text segment of the textual content into a vibration segment according to at least one vibration encoding such as Morse code or blind and deaf sings encoding. The serial visual presentation module respectively enables presenting these vibration segments by controlling a vibration module of the user device.

According to some embodiments of the present invention, there is provided a method of presenting textual content over a display area of at least one user device. The method comprises receiving a plurality of text segments of textual content, identifying relative location of each text segment in relation to the textual content, consecutively displaying the text segments over the display area, and presenting of at least one indication relating to the identified relative location of each text segment, in real time, upon displaying of a respective text segment.

The steps of the method are optionally carried out in real time.

Optionally, the method further comprises preliminary segmentation of the textual content into the text segments by dividing the textual content into text segments in advance prior to presenting of the first text segment, where the relative location identification includes preliminary identification of the relative location of each of the text segments.

Optionally, the method further comprises retrieving code from an online content source, extracting textual content and structural elements from the retrieved code, and dividing the textual content into the plurality of text segments according to the structural elements.

According to some embodiments of the present invention, there is provided a system of presenting textual content over a display area of a plurality of user devices. The system comprises a central system, which receives textual content from at least one content source, analyzes the received textual content and divides the textual content into a plurality of text segments, according to the analysis, and a plurality of user devices each receives the plurality of text segments from the central system and consecutively displays the plurality of text segments over the display area each substantially simultaneously with at least one indication relating to a relative location thereof in the textual content.

According to some embodiments of the invention, there is provided a method of presenting textual content over a display area of a user device. The method comprises receiving textual content from a content source, detecting pupil movements of a user watching a serial visual presentation of a plurality of textual segments of the textual content, determining emotional reaction of the user to each of the textual segments by identifying at least one pupil movement, assigning a complexity level to each of the textual segments according to a respective at least one pupil movement, and adapting another serial visual presentation of at least some of the plurality of text segments each according to a respective assigned complexity level. The at least one pupil movement is optionally indicative of a focus level.

According to some embodiments of the present invention, there is provided a system of presenting textual content over a display area of a handheld user device. The system comprises at least one sensor for reading at least one environmental parameter in proximity to a user using the handheld user device, an analysis module which receives a plurality of text segments of a textual content, and a serial visual presentation module which adapts serial visual presentation of the plurality of text segments according to the at least one environmental parameter. According to some embodiments of the present invention, there is provided a method of presenting textual content over a display area of a user device. The method allows calculating an estimated reading time for reading the textual content to be presented. Once the estimated reading time is calculated, it is presented upon presentation of a hyperlink referring to this textual content. The hyperlink and estimated reading time are presented over the display area of the user device, so as to allow a user thereof to view the estimated reading time prior to linking to the respective textual content.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of the

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the present invention could be implemented as a chip or a circuit. As software, selected steps of the present invention could be implemented as a plurality of software instructions being executed by a computer using any suitable operating system. In any case, selected steps of the method and system of the present invention could be described as being performed by a data processor, such as a computing platform for executing a plurality of instructions.

### BRIEF DESCRIPTION OF THE DRAWINGS

The present invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the present invention, the description taken with the drawings making apparent to those skilled in the art how the several forms of the present invention may be embodied in practice.

In the drawings:

FIG. 1 is a block diagram which schematically illustrates a user device enabling serial visual presentation of content over a display area, according to some embodiments of the present invention;

FIG. 2 is a block diagram which schematically illustrates a system of serial visual presentation of content over a display area of a user device, according to some embodiments of the present invention;

FIG. 3 is a block diagram which schematically illustrates a user interface of a system of serial visual presentation of content over a display area of a user device, according to some embodiments of the present invention;

FIG. 4 is a block diagram which schematically illustrates a server system of serial visual presentation of content over a display area of a user device, according to some embodiments of the present invention;

FIG. 5 schematically illustrates a serial visual presentation configuration for displaying text segments and indications related to relative location of the displayed text segment, according to one embodiment of the present invention;

FIG. 6 schematically illustrates a serial visual presentation configuration for displaying text segments and indications related to relative location of the displayed text segment, according to another embodiment of the present invention;

FIG. 7 schematically illustrates a serial visual presentation configuration for displaying text segments from a webpage and indications related to relative location of the displayed text segment, according to yet another embodiment of the present invention;

FIG. 8 schematically illustrates a serial visual presentation configuration for displaying text segments from an email message and indications related to relative location of the displayed text segment, according to another embodiment of the present invention;

FIG. 9 schematically illustrates a serial visual presentation configuration for displaying text segments from textual content of a social web application and indications related to relative location of the displayed text segment, according to an additional embodiment of the present invention;

FIG. 10 schematically illustrates a serial visual presentation configuration for displaying text segments from textual content of a web application and indications related to relative location of the displayed text segment, according to yet another additional embodiment of the present invention;

FIG. 11 is a flowchart, schematically illustrating a method of serial visual presentation of content over a display area of a user device, according to some embodiments of the present invention; and

FIG. 12 is a flowchart, schematically illustrating a process of presenting a hyperlink to a textual content and reading time thereof over a display area of a user device, according to some embodiments of the present invention.

### DESCRIPTION OF EMBODIMENTS OF THE INVENTION

The present invention generally relates to the field of content presentation and more particularly to Rapid Serial Visual Presentation (RSVP) of content

The present invention, in some embodiments thereof, provides systems and methods of serial visual presentation, segments of textual content, over a display area, and a simultaneous indication relating to the relative location of the segments in textual content and/or remaining reading time estimation indicative of the time the user has to spend reading before finishing the textual content or parts thereof. The display area is optionally a handheld device such as a mobile phone, personal digital assistant (PDA), a laptop, a tablet, and the like. The textual content may be received or retrieved from a content source such as from a document, an email message, a webpage, and the like. The textual content is optionally divided, locally or remotely, into text segments in advance.

The remaining reading time estimation which is presented with every segment is continuously recalculated according to the relative location of the segment in the textual content. The presentation of the relative location and/or the reading time estimation provide the user with a real time indication regarding the estimated length of the textual content left to read.

The system may carry out a structural analysis of the received textual content. The structural analysis is used for adapting the serial visual presentation of the text segments, the reading time estimation calculation, and optionally, for dividing of the textual content into text segments according to the structural analysis. The structural analysis may include identification of structural elements in the textual content such as punctuation marks or tags indicating the structure of the text. The structural elements allow dividing the textual content into text segments according to the structure of the textual content. For example, the analysis may enable identification of sentences by identification of periods. The segmentation of the textual content may be carried out by first dividing the textual content into sentences and then into smaller chunks according to other punctuation marks such as commas, semicolons, etc.

Additionally or alternatively, the structural elements further allow allocating presentation periods for presenting each segment and/or interludes for pausing between segments. The allocated presentation periods and/or interludes may be used in calculating of the reading time estimation. For example, the reading time estimation is calculated by adding up all the allocated presentation periods and/or interludes of the textual content, sentence, chapter, and the like.

The system may additionally or alternatively carry out a content analysis. The content analysis performs segmentation of the textual content into text segments according to complexity of the words in the textual content. For example a sentence including complicated words may be divided into smaller segments than a sentence including words of lower complexity. The presentation period and/or interlude allocated to each text segment may further be adapted according to the complexity level of the entire segment.

The content analysis provides the user with a much more natural way of reading the text segment, by allowing setting a natural reading rhythm by controlling presentation periods and interludes of the segments and by controlling the segmentation of the textual content according to its complexity. The allocated presentation periods and/or interludes may be used in calculating of the reading time estimation.

The system may additionally or alternatively carries out a contextual analysis. The contextual analysis includes, for instance, identification of the type or the source of the textual content, the length of the textual content, the language of the textual content, and the like. The serial visual presentation of the text segments may be adapted according to the contextual analysis. For example, if the textual content is an email message, the serial visual presentation adaptation may include presenting of the textual content word-by-word and allocating a relatively short presentation period and interlude for each text segment. If the textual content is a poem, the segmentation may include dividing the content according to the lines of the poem, and so forth.

Alternatively or additionally, the systems and methods perform an environmental analysis relating to environmental reading conditions of the user for adapting serial visual presentation of the text segments accordingly. The environmental analysis includes receiving environmental data relating to the user such as data received from sensors relating to the location of the user and/or information relating to the illumination conditions for reading, and adapting the serial visual presentation of the text segments, such as the presentation period and/or interludes allocated to each segment, according to received environmental data. The allocated presentation periods and/or interludes may be used in calculating of the reading time estimation. This allows providing the user with a serial visual presentation of content adapted to the user's environmental conditions and limitations.

For example, the graphical presentation of the text segments and/or of the background for presenting the text segments may be adapted to illumination conditions of the user, which are determined according to the geographical location of the user and/or time of the day.

Optionally, a personal analysis may be carried out, for adapting the presentation of the text segments to personal reading pattern and conditions of the user. For example, the system may analyze the reading pace of the user and adapt the presentation period for presenting each text segment and/or the interludes between text segments accordingly.

The reading pace of the user may additionally be used in calculating of the reading time estimation. For example, the calculation is carried out by multiplying the user's average reading pace of a word by the number of words left to read in the textual content, a sentence, a paragraph, or a chapter associated with the currently displayed segment.

Additionally or alternatively, the system performs a statistical analysis of reading patterns of a plurality of users, using a plurality of user devices for adapting the serial visual presentation of the text segments accordingly. For example, an average reading pace may be calculated for each language, using information arriving from a plurality of users to determine an average number of words per time unit. The average reading pace may then be used for adapting presentation periods and/or interludes of text segments.

The system optionally enables inserting visual effects associated with some of the words in some of the text segments. Words that are associated with visual effects may be presented according to the effect assigned to them. The visual effects may include bolding, tilting, coloring and/or animation of the letters of the associated word. The inserting of visual effects may further include presenting of an image or a short animation or video upon presentation of the word.

The systems and methods may further enable the user to navigate through previously displayed text segments by allowing storage of previously displayed segments at the user device or at a remote storage unit.

Before explaining at least one embodiment of the present invention in detail, it is to be understood that the present invention is not limited in its application to the details of construction and the arrangement of the components set forth in the following description or illustrated in the drawings. The present invention is capable of other embodiments or of being practiced or carried out in various ways. Also, it is to be understood that the phraseology and terminology employed herein is for the purpose of description and should not be regarded as limiting.

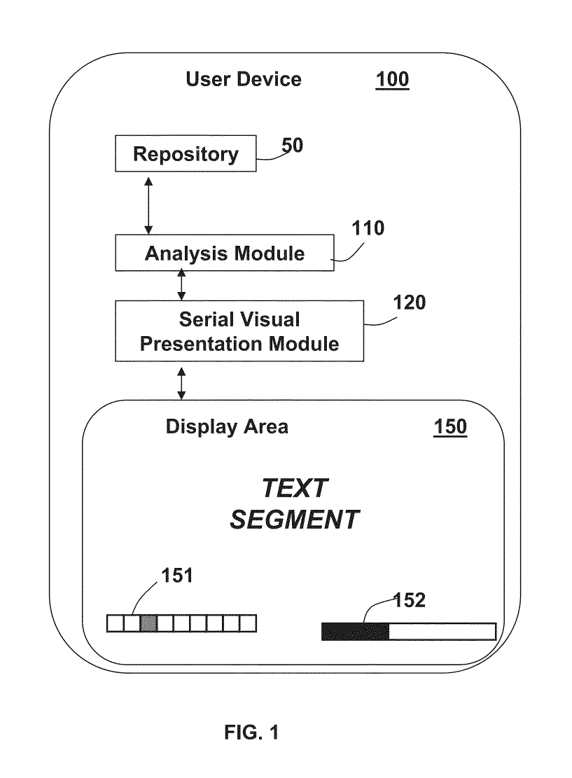

Reference is now made to FIG. 1, which is a block diagram that schematically illustrates a user device 100 which presents content over a display area 150 of the user device 100, according to some embodiments of the present invention.

The user device 100 may be any electronic device enabling displaying of textual content over the display area 150. The user device 100 may further enable processing of data and/or communication over one or more communication links with external communication systems and devices. The user device 100 may be a handheld set such as a mobile phone, a PDA, a laptop, a tablet, an eye screen device, or a stationary device such as a computer system or a projector system. The display area 150 of the user device 100 may be any display area known in the art whether a limited display area such as a mobile phone screen or a larger size display area such as a computer screen or a display area of a projector.

As illustrated in FIG. 1, the user device 100 includes an analysis module 110, which receives text segments of textual content, identifies relative location of each of the text segments in relation to the textual content and, optionally, calculates one or more parameters relating to the relative location of each segment.

A text segment may include one or more words, depending on device definitions such as screen size, or depending on preliminary analysis of the textual content. The text segments may be received or retrieved from any device, application, module, or system that allows dividing the textual content received or retrieved from a content source into text segments according to any segmentation technique. The division into text segments may be carried out by the analysis module 110 or by any other external or internal module.

As illustrated in FIG. 1, the user device 100 further includes a serial visual presentation module 120 enabling consecutive displaying of the text segments over the display area 150 while simultaneously presenting one or more indications of their relative location and/or reading time estimation.

The relative location of each text segment may be defined as the location of the text segment in relation to the beginning and/or the end of the entire textual content. The calculation of such a relative location is based on the number of text segment preceding the displayed text segment and/or in relation to the number of acceding text segments yet left to read. Alternatively, the relative location of a currently displayed text segment may be defined as the location of the text segment in relation to the end/beginning of a sentence, a paragraph and/or any textual structure. For example, the relative location is the location in relation to the end of a sentence and the analysis module 110 checks the relative location of the last word in the text segment in relation to the end of the sentence. The end of the sentence may be identified by a period mark in the following textual content.

An indication 151 of the relative location of each text segment may be presented over the display area 150 according to graphical presentation definitions. For example, as illustrated in FIG. 1, in a case where the relative location is calculated as the location of the text segment in relation to the end and the beginning of a paragraph containing the currently displayed segment, a graphical display of boxes may be presented, for example. The currently displayed text segment is indicated by a colored box, and all other text segments in the associated paragraph are indicated by empty boxes. Text segments that have been previously displayed are indicated at the left of the colored box and the text segments that were not yet displayed are indicated at the right of the colored box.

As outlined above, a remaining reading time estimation may be displayed simultaneously and adaptively to the consecutively displayed text segments.

The reading time estimation indicates a remaining reading time prediction, which is an estimation of the time left for the user to read the rest of the textual content, paragraph, sentence, and/or the like. Such estimation may be referred to herein as “time to read” parameter. The time to read parameter may be estimated by multiplying the number of unread text segments or the number of words in all unread text segments by a predefined time parameter. The predefined time parameter may be a pre-calculated average time for reading a text segment or an average time for reading a word of an average length.

The time parameter may be calculated according to statistical estimation of an average word/segment reading time. Alternatively, the time parameter is calculated according to personal reading time of a word/segment of the user in relation to the user' environmental conditions and/or in relation to the context of the unread textual content. The context may be related to estimation of words complexity, where each word in the unread textual content may be multiplied by a different time parameter associated with the complexity of the word

An indication 152 of the time to read evaluated for the currently displayed text segment may be presented in the display area 150 substantially simultaneously therewith. For example, as depicted in FIG. 1, the time to read indication 152 indicates the estimated remaining reading time for reading the entire textual content. In this example, an elongated rectangular box is presented where the scale of the entire box represents the entire estimated time for reading the entire textual content, a colored portion of the rectangular box represents the reading time that has passed, and an empty portion represents the estimated time to read. In other embodiments, the time to read estimation may be indicated by a number representing the estimated time to read in minutes, or by a slider representing the time location of the displayed text segment over a time scale.

The identification of the relative location of the text segment and the calculation of the time to read parameter may be carried out in real time, by the analysis module 110. In this case, the text segments are received or retrieved in real time and the identification and calculation are carried out substantially upon receiving/retrieving the text segment.

Alternatively, the analysis module 110 receives all text segments in advance and carries out a preliminary analysis including the identification of the relative location of each segment and calculating of the time to read parameter of each text segment prior to presenting of the text segments and of the indications.

Optionally, the analysis module 110 and the serial visual presentation module 120 are configured as an RSVP application installed in or uploaded to the user device 100.

The analysis module 110 and the serial visual presentation module 120 may be adapted to support one or more languages depending on predefined configuration of the application.

According to some embodiments of the present invention, as illustrated in FIG. 1, the user device 100 further includes a repository 50 for storing of data therein and retrieval of data therefrom. The repository 50 may be used, for example, for storing parameters such as the time parameter for calculating the time to read. Additionally or alternatively, the repository 50 enables storing unread text segments and deleting read text segments, according to predefined application definitions and depending on cache size of the user device 100 and/or on cache strategy.

According to some embodiments of the present invention, the analysis module 110 can extract additional data relating to the user from external devices and sources to further adapt serial visual presentation of text segments accordingly. For example, the analysis module 110 retrieves biometric data relating to the user's activity such as exercising activity, driving activity and the like and analyzes this data. The serial visual presentation module 120 then adapts serial visual presentation of the text segments according to the analysis of the additional data.

The analysis module 110 and the serial visual presentation module 120 may further enable presentation of text segments and relative location related indications through various gadgets and devices. The analysis module 110 and serial visual presentation module 120 may additionally adapt the serial visual presentation according to data received from the gadget and/or gadget functionalities. One example of such a gadget is a wrist watch adapted for exercising, which measures biometric parameters of the user such as the user's running or walking speed, heartbeat, and the like and indicates calories burning, heart beat and running/walking speed. The analysis module 110 extracts data relating to the exercise from the watch such as the running/walking speed, heart beat and the like, and the serial visual presentation module 120 adapts serial visual presentation of the text segments accordingly. For example, the segmentation of the textual content into text segments and/or the allocation of the presentation period and/or interludes of each segment may be adapted according to the running/walking speed of the user. This adaptation allows the user to comfortably read textual content such as messages while exercising.

Another example for such a gadget is a car gadget designed to allow serial visual presentation of segments from text messages only on a full stop position of the car, where the car gadget is operatively associated with the car computer and/or ignition mechanism. Yet another example is a projector system having the RSVP associated therewith allowing projecting the text segment of textual content over a screen, where the presentation is adapted to the screen size and personal settings of the presenter.

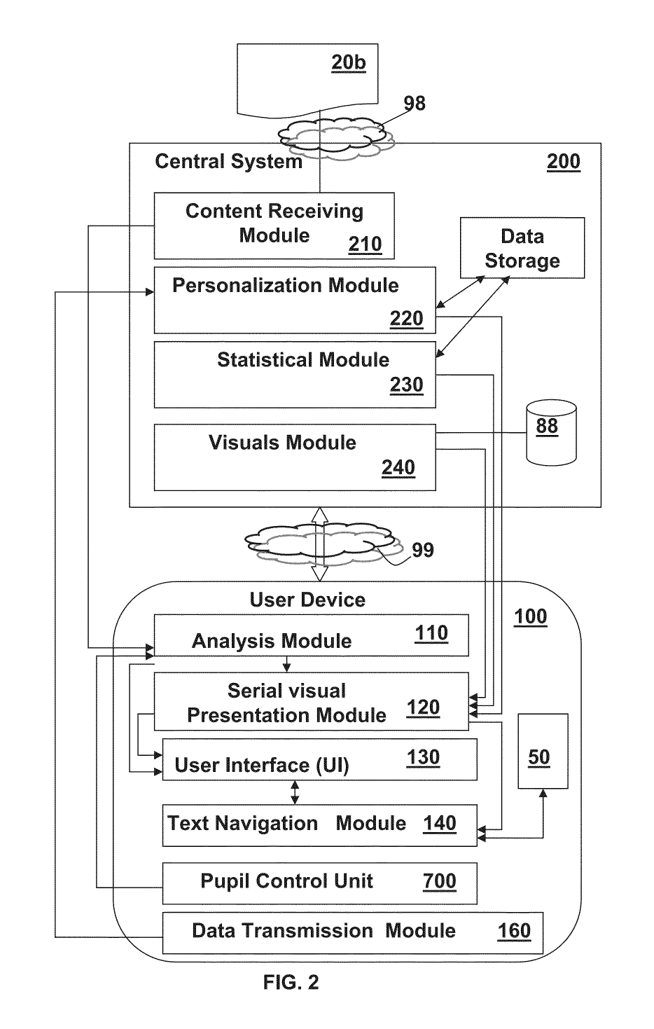

Reference is now made to FIG. 2, which is a block diagram, which schematically illustrates a system of presenting content over the display are 150 of the user device 100, according to some embodiments of the present invention.

The user device 100, in this case, is operatively associated with a central system 200, enabling communication therewith through one or more communication links such as through a wireless communication link 99. In this case, the user device 100 is a wireless communication device such as a mobile phone, an iPhone, a PDA, and the like. The user device 100 may use any network technology for communicating with the central system 200 such as the internet, Wireless Application Protocol (WAP), Short Messaging Service (SMS) and/or Multimedia Messaging Service (MMS) or any other information transmission technology, and the like.

According to some embodiments of the present invention, as illustrated in FIG. 2, the central system 200 includes a content receiving module 210, which receives or retrieves textual content by accessing one or more content sources of one or more content types. For example, the content receiving module 210 may retrieve textual content from a webpage 20 of a website by communicating with website sources over one or more communication links such as through an internet link 98. The textual content may be received or retrieved from any content source known in the art such as from articles, word documents, message of various messaging services such as email messages, SMS messages, and the like.

Once the content source is accessed the content receiving module 210 extracts textual content from the content source, according to the structure and type of the source. For example, if the content source is a webpage, the content receiving module 210 may enable accessing the webpage Uniform Resource Locator (URL) and extracting the textual content by reading the Hyper Text Markup Language (HTML) code or any Extensible Markup Language (XML) based code of the webpage and identifying tags relating to textual content.

The content sources may further include an XML based RSVP (RSVPML) content, which is an enhanced form denoting RSVP features, including references to text segments, words, complexity levels of words, punctuation marks, end of line/paragraph, chapter indication, and the like. The RSVPML may further include indication and information relating to non-textual content or extended text such as images and hyperlinks. In some cases the RSVPML may additionally include output indications resulting from complicated linguistic analysis, such as query indications, humor indications, and the like. These indications would be pre-tagged in the textual content prior to being received/retrieved by the content receiving module 210.

According to some embodiments of the invention, the analysis module 110 may additionally enable receiving the textual content from the content receiving module 210 and analyzing it to allow adaptation of the serial visual presentation of the text segments according to analysis of the textual content. The adaptation may include the identification of the relative location and time to read parameter of the segments and optionally, dividing the textual content into text segments.

Optionally, the analysis module performs a structural analysis of the textual content by, for example, identifying structural elements of the textual content, such as punctuation marks, to indicate beginning and ending of sentences, beginning and ending of paragraphs and the like.

Additionally or alternatively, in cases where the retrieved textual content is an online textual content, such as an article, a webpage, a blog, and the like, the identification of structural elements includes identification of tags indicating structure of the article such as title, abstract, and the like. The textual content may be divided into text segments of different words number and of different words length, according to the contextual analysis of the textual content.

According to some embodiments of the present invention, the structural analysis of the textual content further includes assigning predefined interlude periods and presentation periods according to the identified punctuation marks or other structural elements of the textual content. For example, an interlude may be inserted after a comma, a period, a semicolon and the like, where each punctuation mark is allocated with the same or with a different interlude. For instance, a comma may be followed by an interlude of t1, a period may be followed by an interlude of t2 and a semicolon may be followed by an interlude of t3, where t1 may be smaller than t2, t2 may be larger that t3, and so forth. The allocated presentation periods and/or interludes may be used in calculating of the time to read parameter. For example, the time to read parameter is calculated by adding up all the allocated presentation periods and/or interludes of the textual content, sentence, chapter, and the like.

Additionally or alternatively, the analysis module 110 performs a content analysis. The content analysis may include assessing the complexity level of each word in the textual content and optionally, divide the textual content into segments according to the complexity of the words in the textual content. In this case, the content analysis may include assigning a complexity rank to each word, where the complexity rank represents the complexity level of the word. The complexity rank may be calculated or estimated according to various analytical approaches. For example, a high complexity level may be assigned to long words and/or to words that are not commonly used and a low complexity level may be assigned to short words and/or commonly used words. The analysis module 110 may access a ranking table for allowing assigning a complexity rank to each word in the textual content. The table includes a list of words and a list of complexity ranks, where each word is associated with a complexity rank. The analysis module 110 may divide the textual content according to the complexity ranks of the words in the textual content, using the table to identify the complexity rank assigned to each word in the textual content. The dividing into text segments may be carried out by allowing a maximal rank in a single text segment. The maximal rank may be calculated as the summation of ranks of words. For example, the rank may be a number between one and ten, where the maximal rank of a text segment may be defined as five, only allowing inserting consecutive words into a segment that have a rank summation under or equal to five. Therefore, if we have a string of words of ranks 3, 2, 4, and 5, the segmentation may result in: a first segment including the first and the second words, a second segment including the third word, and a third segment including the fourth word. Therefore, the number of words in each text segment may vary and may be determined according to the complexity-based contextual analysis.

Additionally or alternatively, the assignment of complexity level to words may be a learning process in which the assignment is carried out according to analysis of personal reading experience of the user. For instance, the analysis module 110 learns which words take longer time for the user to read, in each language, and assigns the complexity levels accordingly. The analysis module 110 therefore updates the ranking table with every reading session to adapt the table to the reading experience of the user.

The learning process may involve identification of reading patterns of the user or a plurality of users and updating complexity ranks accordingly. For example, the learning process may identify that words that are associated with specific fields such as words associated with emotions, senses, professional fields and the like, take longer for the user(s) to read and update complexity level of words associated with those fields accordingly, e.g. by automatically increasing complexity ranks of words associated with those fields.

Additionally or alternatively, the adaptation of serial visual presentation of text segments further includes adaptation of presentation period of each text segment. The presentation period represents the time for displaying each text segment. The adaptation may be carried out according to the content analysis of the textual content. For example, the presentation period may be adapted according to the total complexity rank of the text segment. If the total summation of ranks of one text segment is 4 and of a second text segment is 3, the first text segment, having a higher total complexity rank may be allocated with a longer presentation period than the second text segment having a lower complexity rank.

Additionally or alternatively, the adaptation of serial visual presentation of text segments further includes allocating an interlude for each text segment, where the interlude is a pausing time inserted after the displaying of a text segment before displaying of the next consecutive text segment. The adaptation may be carried out according to the content analysis of the textual content. For example, the interlude may be adapted according to the total rank of the text segment, allocating a longer pause after a segment of a higher rank, and so forth. The allocated presentation periods and/or interludes may be used in calculating of the time to read parameter.

Additionally or alternatively, the analysis module 110 performs a contextual analysis for adapting the serial visual presentation of text segments and/or segmentation of the textual content, according to the text type. For example, for presentation of lyrics of a musical song or a poem, the textual content may be segmented according to the song/poem phrases and the text segments serial visual presentation may be coordinated and synchronized with the music of the song when played. For serial visual presentation of text messages the adaptation may include selecting a different color of the text of each part of the message. For example, the subject may be presented in a first color where the body of the message may be presented in a different color.

The analysis module 110 additionally or alternatively performs an environmental analysis of data received from external or internal sources such as from the user device 100 and/or other sensors.

The analysis module 110 receives or retrieves environmental data relating to the user from the user device 100 and/or from external sensors and adapting the serial visual presentation of the text segments according to the received or retrieved environmental data. The analysis module 110 may receive, for example, GPS or any other location related data from the user device 100 enabling to locate the user and optionally to detect movement of the user, time data including the time in the day in which the user reads the text segments, and the like. The data may be processed and analyzed by the analysis module 110 to allow adapting letters size, font, color, background illumination and/or color, contrast definitions, interludes and presentation periods of the text segments, according to the analysis results.

For example, the received geographical location of the user combined with the time of reading may indicate the illumination conditions for reading the text segments. If the illumination conditions are poor e.g. it is night and the user is outdoors—the analysis module 110, associated with the serial visual presentation module 120, may determine presentation of the text using large font size, light color of the display background and high contrast between the background and the words of the text segments, as well as allocation of relatively long interludes and/or presentation periods. The allocated presentation periods and/or interludes may be used in calculating of the time to read parameter.

The analysis module 110 may extract additional information relating to the environmental data such as information relating to the location of the user where the serial visual presentation module 120 adapts serial visual presentation of the text segments and/or background of the display area 150 accordingly. For example, the analysis module 110 extracts or receives information relating to providers of services and products that are stationed in a neighboring surroundings of the user's location. The providers may be restaurants, shops, offices and the like. The serial visual presentation of the text segments is then adapted according to the neighboring providers by, for example, presentation of logo and address of the nearby providers accompanying the serial visual presentation of the text segments. The presentation may also include offers such as discounts or coupons for users who pass through the provider. The presentation of the added information may be carried out using augmented reality features such as presentation of a picture of a sign post of the provider that is positioned in the neighboring environment.

The environmental data may further include data relating to the orientation of the display area 150. Optionally, the analysis module 110 adjusts the orientation presentation of the text segments according to the orientation of the display area 150. For example, if the user holds the user device 100 in a horizontal orientation—serial visual presentation of the text segments may be horizontal.

According to some embodiments of the present invention, the central system 200 further includes a personalization module 220 operatively associated with the serial visual presentation module 120. The personalization module 220 may analyze the reading pace of a user associated with the user device 200. The calculation of the time to read prediction may be carried out according to the personal reading pace of the user. The personalization module 220 may monitor user reading habits during a period of a few day/weeks/months and the like to determine the average reading pace of the user. The reading pace may be calculated as the average number of words read within a predefined time unit or the average number of text segments read within a predefined time unit. The personal reading pace of the user may be changed over time as more reading sessions of the user may allow refining the average pace. The calculated reading pace may allow further adaptation of the presentation period and/or interlude associated to each text segment. For example, the analysis module 110 may enable allocating longer interludes and longer presentation periods to each text segment for a user of a low reading pace and vice versa.

The personalization module 220 may enable refining the presentation period and interlude already allocated to a text segment by adding a constant period for the allocated presentation periods and/or the allocated interludes of the text segments. Therefore, even if the already allocated presentation periods and/or interludes are not the same for all segments, e.g. due to the content analysis, a constant addition to these presentation periods and/or interludes is added, where the constant addition is calculated according to the reading pace of the user.

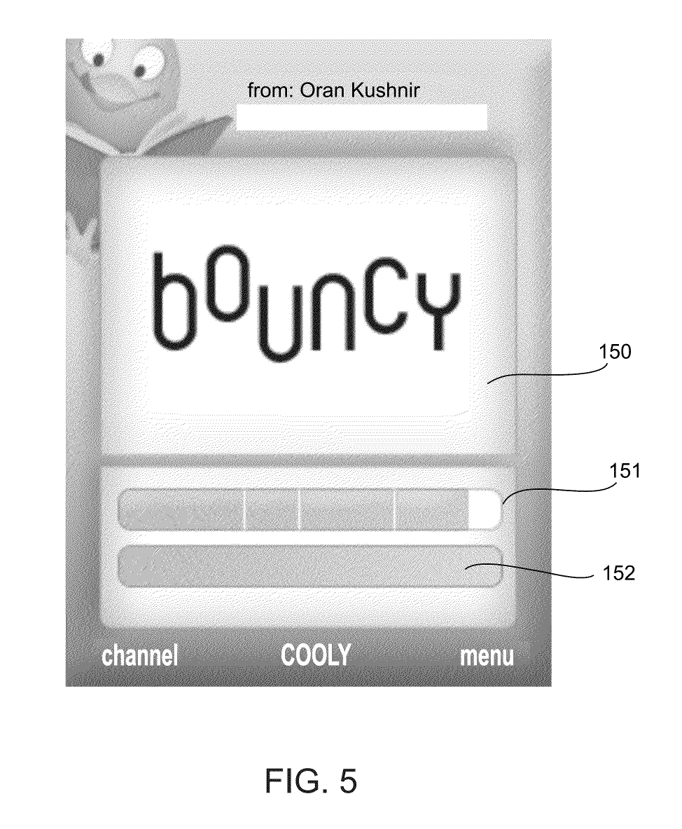

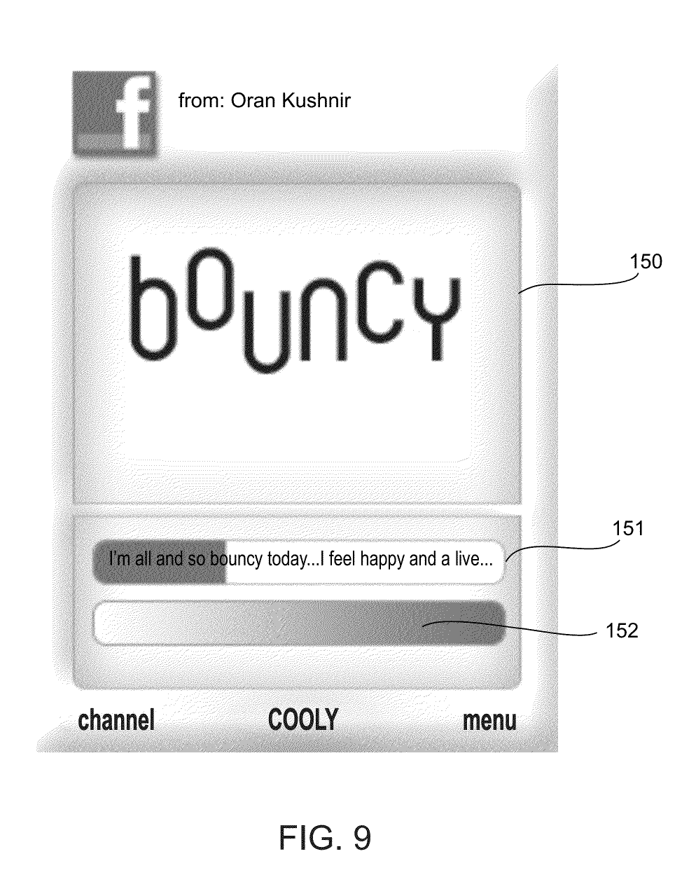

The personalization module 220 may further receive personal data inputted by the user, where the input data is transmitted to the personalization module 220 through a designated data transmission module 160. The input data allows determining the reading pace and/or other graphical characteristics of the serial visual presentation of the text segments. For example, the user may be presented with a list of “moods” each mood associated with a predefined different presentation settings, such as reading speed, which relates to definitions of the presentation period and interlude of each text segment, text font, size and color, and the like. The moods list may include: a Solid Mood, associated with a predefined “normal” reading speed and “normal” text presentation characteristics, a Competitive Mood, which indicates the user's reading speed as he/she reads, a Quiet Mood, associated with a predefined reduced reading speed, a Wild Mood, which emphasizes words associated with emotional responses such as “hot” or “great”, by changing graphical characteristics such as letter size, backlight, and the like for enhancing the emotional experience when reading the text segments. An additional or alternative mood is a Meaning Mood, which adapts presentation of words in the text segments according to the meaning of the word. For example, the word “bouncy” may be presented in a bouncy presentation, such as shown in FIGS. 5 and 9. Once the user selects a mood the reading speed and presentation settings may be automatically defined allowing personal adaptation of the serial visual presentation according to the user's selection.

According to some embodiments of the invention, as illustrated in FIG. 2, the central system 200 further includes a statistical module 230, operatively associated with the serial visual presentation module 120. the statistical module 230 may enable accumulating information including reading patterns of a plurality of users using a plurality of user devices, analyzing the accumulated information and adapting serial visual presentation of text segments and calculation of the time to read parameter, according to the statistical analysis of the accumulated information. For example, the statistical module 230 accumulates average reading pace parameters of a plurality of users and analyzes the correlation between the reading pace of a text segment and the maximal complexity rank of that text segment. The results of the statistical analysis may allow adjusting the maximum complexity rank accordingly. If the maximal complexity rank defined at the analysis module 110 is five, as in the example given above, and the total average reading pace of all users is low in comparison with a predefined normal average pace, the analysis module 110 may allow updating the maximal complexity rank by lowering it down to four, for instance, upon receiving statistical analysis results from the statistical module 230. This updating process may be carried out at predefined time intervals for allowing the statistical module 230 to constantly accumulate statistical information relating to users and correspondingly constantly updating analysis definitions of the analysis module 110.

According to some embodiments of the present invention, as illustrated in FIG. 2, the central system 200 further includes a visuals module 240, operatively associated with the serial visual presentation module 120. The visuals module 240 may allow associating words from the text segments with visual effects, where the serial visual presentation module 120 allows presenting associated visual effects upon presentation of each of the associated word.

The visual effects may be any visual effect known in the art such as, for example, bolding, underling, and/or increasing font size of words in the associated text segment, presentation of media elements such as a picture, a graphic element, a commercial element, bouncing, flickering or shaded words, and the like.

The visuals module 240 may include a list of words coordinated with a list of visual effects and/or a list of links to visual effects. These lists may be stored in a database 88 having a predefined data structure that allows association of the words to the effects and/or links. The visuals module 240 may further enable identifying words in the text segments that are associated with a visual effect or a visual effect link, in real time. Once an associated word in the text segment is identified the visual effects module 240 enables retrieving/linking to the visual effect to allow inserting the effect to the text segment or alternatively (depending on the effect) transmitting graphical characteristics for displaying of the associated word to the serial visual presentation module 120. The serial visual presentation module 120 may then present the word according to the graphical characteristics or alternatively insert the effect from the link or from database 88.

A visual effect may be associated with more than one word. For example, an advertising related effect of a product may be associated with all the words, which are related to this product or to the field of products it relates to. For example, an effect that includes presenting a predefined picture of a bottle of Coca Cola drink may be associated with all words relating to the field of drinks such as: drink, thirsty, bottle, can, liquid, and the like. The visual effect may further be associated to words of less obvious relation to the content of the effect such as: summer, friends, cold, hot, and the like.

The association may be carried out manually by an authorized administrator and/or automatically via any known in the art technology and algorithm for associating visual effects content to words.

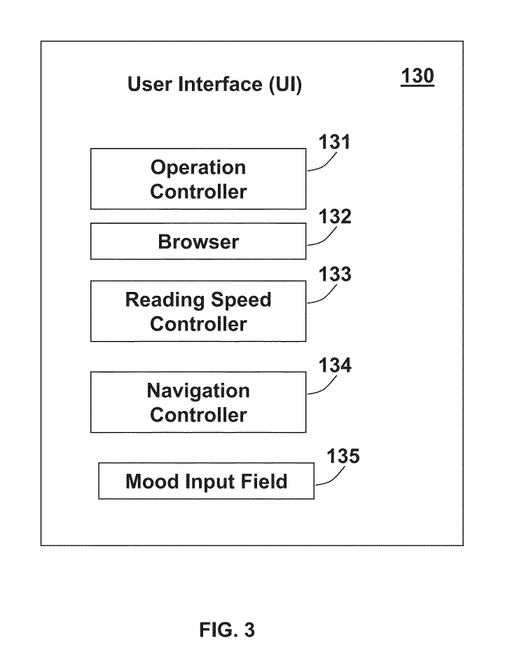

According to some embodiments of the present invention, as illustrated in FIG. 2, the user device 100 further includes a user interface (UI) 130 enabling the user to control one or more functions relating to the serial visual presentation of the text segments. For example, enabling the user to start and terminate a reading session, to determine and control interludes and presentation periods, and the like. Other optional functionalities of the UI 130 will be elaborated in the following description of FIG. 3.

According to some embodiments of the present invention, the user device 100 further includes a text navigation module 160 enabling the user to navigate through previously presented text segments by using the identified relative locations. The text navigation module 160 allows the user, for example, to jump back to a previously displayed text segments and jump back and forth from one previously displayed segment to another.

The text navigation may be enabled by using the repository 50 for storing text segments that were already presented to the user. The repository 50 may allow storage of presented text segments of the textual content at least until the termination of the reading session.

According to some embodiments of the present invention, the user device 100 further includes a pupil control unit 700 operatively associated with the personalization module 220. The pupil control unit 700 may enable tracking the user's gaze by tracking the movement of the user's pupils while reading. The analysis module 110 receives data from the pupil control unit 700 and analyzes the reading behavior of the user, such as focus level of the user in relation to the displayed segment, using the received data. The analysis of the received data allows adapting serial visual presentation of the textual content according to analysis of the user's eye movements. For example, the analysis of the eye movements may reveal that words that are longer than a threshold length or words relating to emotions and/or sensations cause the user to lose focus. Therefore, the analysis module 110 may enable adapting the maximal complexity rank or the complexity rank of words according to the pupil related analysis, e.g. by updating the maximal complexity rank, updating the ranks table by assigning complexity levels to words associated with emotions according to the pupil related analysis, and/or by adapting the interludes and/or presentation periods of text segments including such words. The allocated presentation periods and/or interludes may be used in calculating of the time to read parameter. Optionally, the pupil control unit 700 is connected to an existing front image sensor of handheld device, such as a mobile phone. In such an embodiment, designated hardware is not required.

Reference is now made to FIG. 3, which schematically illustrates the user interface (UI) 130 of the user device 100, according to some embodiments of the present invention.

The UI 130 includes an operation controller 131 for allowing the user to manually start and terminate a reading session, a browser 132 for allowing the user to brows through sources of textual content, a reading speed controller 133 for allowing the user to manually control reading speed e.g. by controlling presentation period and/or interludes, and/or a navigation controller 134 for allowing the user to navigate through previously read text segments during a reading session e.g. jumping back to a previously read segment.

The UI 130 may further include an input field 135 for allowing the user to select a mood for determining presentation settings such as reading speed and/or graphical representation, as discussed above.

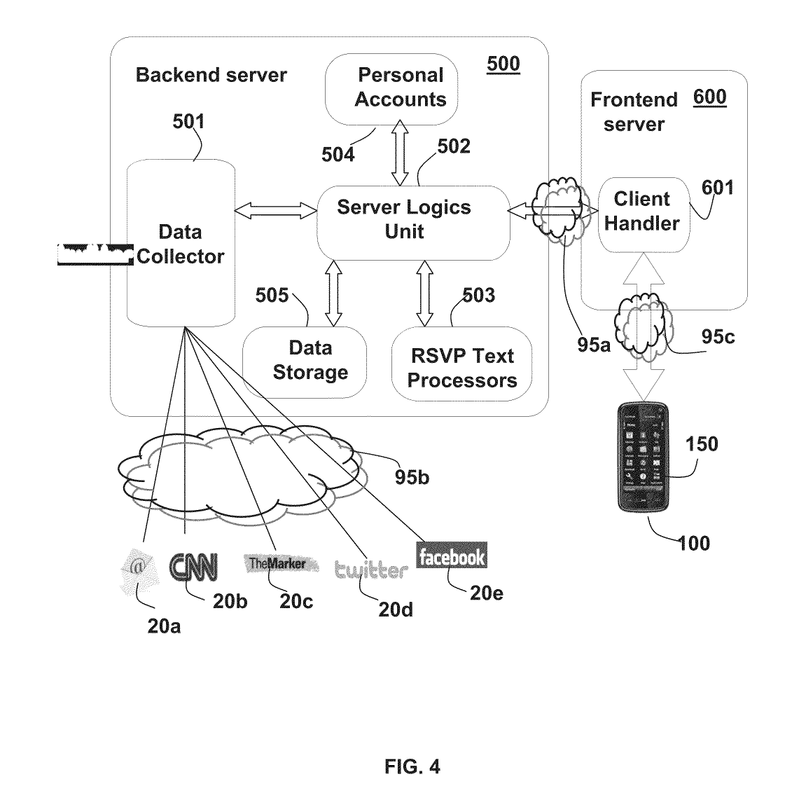

Reference is now made to FIG. 4, which is a block diagram which schematically illustrates a system of presenting content over the display area 150 of a multiplicity of user devices, according to some embodiments of the present invention. The system may include a backend server 500 and a frontend server 600 communicating through one or more communication links such as through an internet communication link 95a.

The backend server 500 may include a data collector 501 enabling to collect data from a variety of content sources such as email messages 20a, webpages including online news articles such as 20b and 20c, messages from networks such as Twitter 20d or Facebook 20e, and the like. The collected data may be processed at a server logics unit 502 enabling to extract textual content from the received webpage or message and identify structural elements in the content such as XML tags, for instance.

The extracted textual content and elements may be further processed at an RSVP text processor 503, which may include the analysis module 120 and other modules functionalities such as functionalities of the personalization module 220, the statistical module 230 and/or the visuals module 240 as previously described.

The backend server 500 may further include a personal accounts manager 504 enabling to manage accounts of a plurality of users using a plurality of user devices 100 of various types. The personal accounts manager 504 may enable a user to open and manage a personal account for serial visual presentation of text segments, relative location and time to read parameter of text segments from the data sources according to the user settings. For example, the personal accounts manager 504 may distribute email, Facebook or Twitter messages to the user, by identifying that the message is addressed to a specific user, and presenting the text segments, relative location and time to read parameter of each text segment of the message to the user according to an analysis of the textual content carried out by the RSVP text processor 503.

The serial visual presentation of the text segments, the relative location and time to read parameter indications and optionally, the presentation of the visual effects, may be adapted according to the analysis carried out at the RSVP text processor 503. The analysis may include at least some of the optional analysis discussed in the description of FIGS. 1-2, such as the contextual analysis, the analysis of personal data of the user, the visuals analysis and/or the statistical analysis.

The backend server 500 may further include data storage 505 for allowing maintaining some of the collected data in memory for analyzing the data at the RSVP text processor 503, and additionally for saving users accounts related data and for providing the users with data upon users' requests.

According to some embodiments of the present invention, the frontend server 600 may include a client handler 601 enabling to communicate with the backend server 500 using one or more communication links such as, for example, through an internet communication link 95c. The client handler 601 may handle communication with the user device 10 through one or more communication links such as through a wireless communication link 95c. The client handler 601 receives and transmits data from and to the server logics unit 502 and receives and transmits data from and to the user device 100. The data received from the server logics unit 502 may include the text segments, the relative location and time to read parameter, visual effects, allocated presentation period and interlude of each text segment, and graphical definitions for presentation thereof. The data transmitted from the user device 100 to the client handler 601 may include control input data to allow the user to control functions such as accessing a personal account of the user, controlling of the starting and terminating of a reading session, control of the retrieval of content (browsing control), navigation control, reading speed control, and the like.

Reference is now made to FIG. 5, which schematically illustrates presentation of a text segment from a Twitter message including the word “bouncy” according to one embodiment of the invention. The word “bouncy” is identified by the visuals module 240 as associated with a visual effect that turns the presentation of the word into a bouncing letters presentation. The presentation further includes links to a menu that may allow returning to the UI control options. The relative location is indicated by a raw of boxes 151 each of a different size, representing the different lengths of the text segments of a paragraph. The currently displayed text segment is presented at the right end of the raw of boxes. The box representing the currently displayed text segment includes a colored portion, representing the time passed from the moment the text segment was displayed and an empty portion, representing the time left for presenting the text segment, according to the allocated presentation period of the currently displayed text segment. The time to read parameter 152 is indicated by a rectangular box where one portion of the box is filled with one color representing the time passed from the beginning of the paragraph and another portion filled by a different color, representing the estimated remaining time to read of the paragraph. The background of the display area 150 may include graphical representation of the source

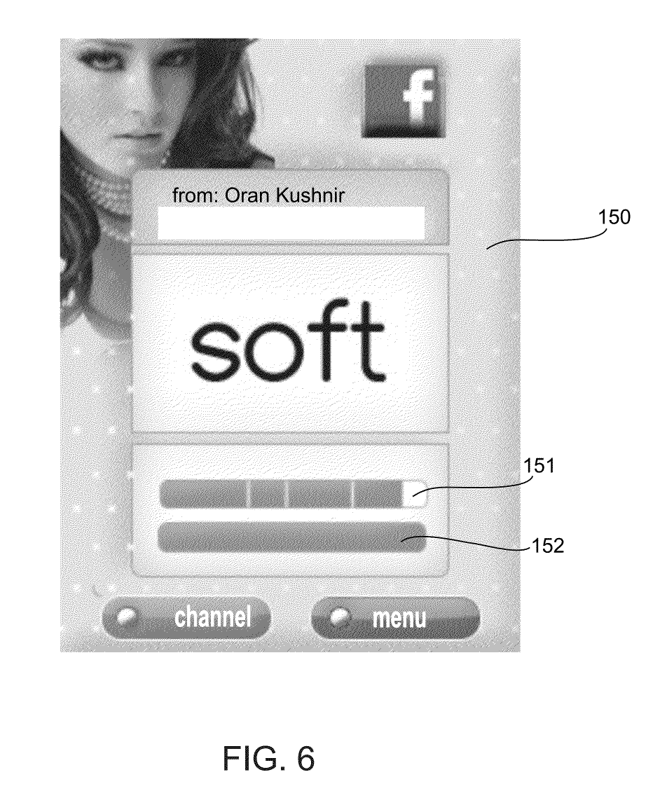

Reference is now made to FIG. 6, which schematically illustrates presentation of a text segment including the word “soft”, where the text segment originates from a Facebook wall, according to another embodiment of the invention. The presentation includes a background image that includes the Facebook logo and an advertisement image relating to the word “soft” presented. In this case the visual effect associated with the word Soft includes inserting of an associated image to the background presentation. The relative location and time to read indications 151 and 152 are represented in the same manner as in FIG. 5.

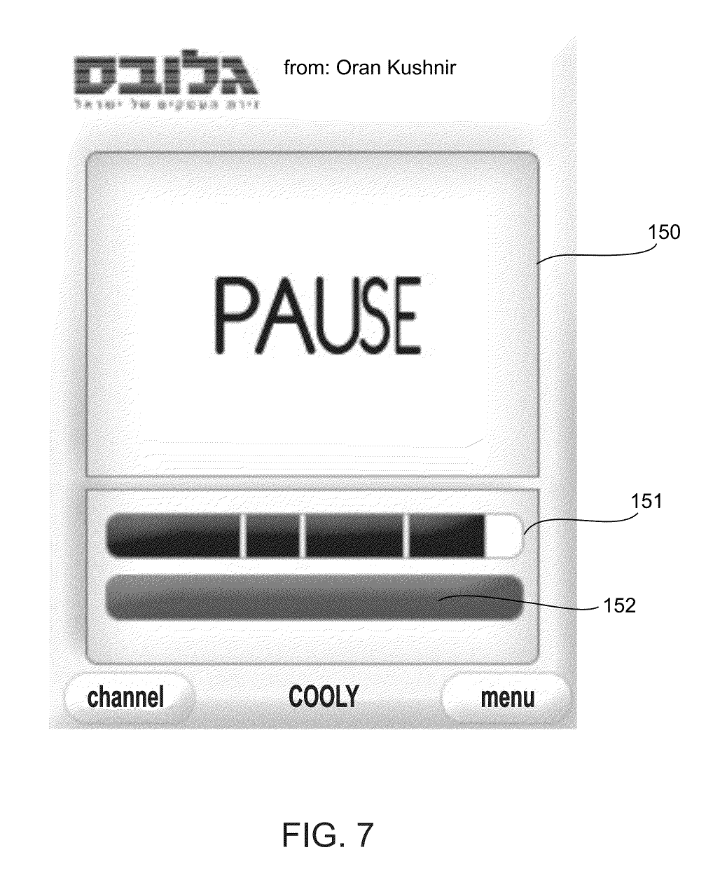

Reference is now made to FIG. 7, which schematically illustrates presentation of a text segment including the word “pause”, where the text segment originates from an online article of a webpage from a news website, according to yet another embodiment of the invention. The presentation includes a background image that includes the website logo. The interlude period or a pause controlled by the user is represented by the word “Pause” over the display area 150. The relative location and time to read indications 151 and 152 are represented in the same manner as in FIG. 5.

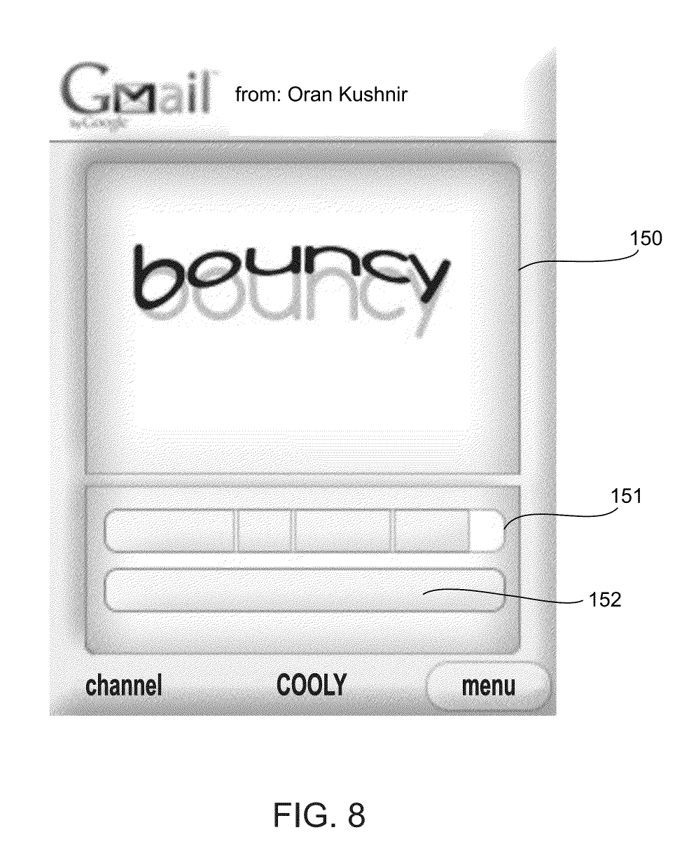

Reference is now made to FIG. 8, which schematically illustrates presentation of a text segment including the word “bouncy”, where the text segment originates from an email message, according to one embodiment of the invention. The word “bouncy” is identified as associated with a visual effect that turns the presentation of the word into a bouncing letters presentation. The presentation includes an indication of the email messaging services logo. The relative location and time to read indications 151 and 152 are represented in the same manner as in FIG. 5.

Reference is now made to FIG. 9, which schematically illustrates presentation of a text segment including the word “bouncy”, where the text segment originates from a Facebook message, according to an additional embodiment of the invention. The text of the entire sentence is further represented in a box below the presentation of the text segment, which includes a single word in this case. The word “bouncy” of the text segment is identified as associated with a visual effect that turns the presentation of the word into a bouncing letters presentation. The relative location indication 151 includes a rectangular box representing the entire sentence that the segment is associated with, where the colored portion of the box represents the already displayed words in the sentence and the empty portion represents the words left to read. The text of the entire sentence is presented upon the relative location indication box 151. The time to read indication 152 is substantially the same as in FIG. 5. The presentation further includes an indication of the Facebook logo upon the background of the display area 150.

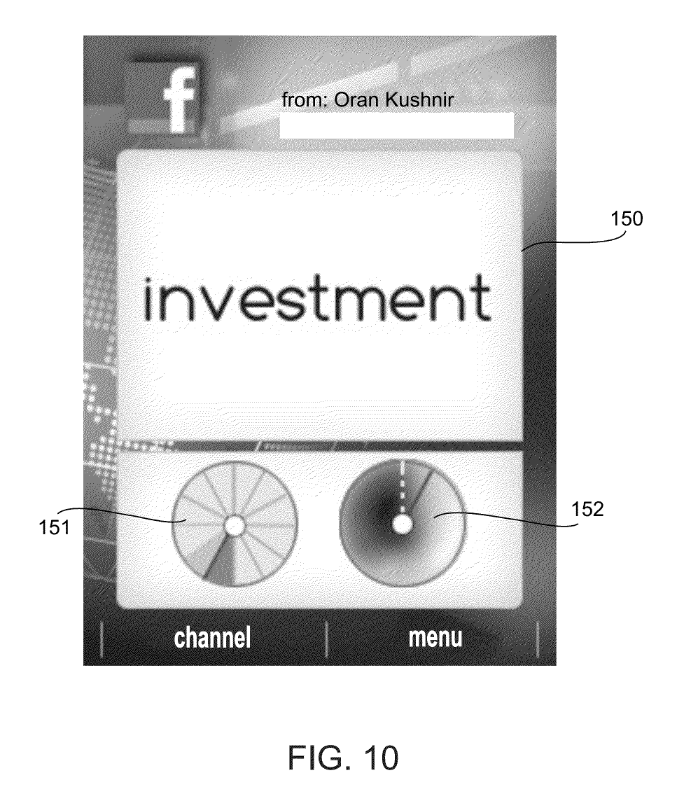

Reference is now made to FIG. 10, which schematically illustrates presentation of a text segment including the word “investment”, where the text segment originates from a Facebook message, according to an additional embodiment of the invention. The relative location indication 151 includes a slices presentation, which is a presentation of a circle constructed by slices, where each slice represents a text segment and all slices constructing the circle represent an entire paragraph or the entire textual content of the message. The currently displayed text segment is represented by a slice filled with one color, the already displayed text segments are represented by slices filled by a different color and the unread text segments are represented by empty slices. The time to read indication 152 includes another sliced circle having two sliced portions, where one sliced portion is colored representing the time that had passed from the beginning of the reading session and an empty sliced portion represents the time to read estimation. In that way the entire circle of the time to read indication 152 represents the estimated time for reading the entire message. The presentation further includes an indication of the Facebook logo upon the background of the display area 150.

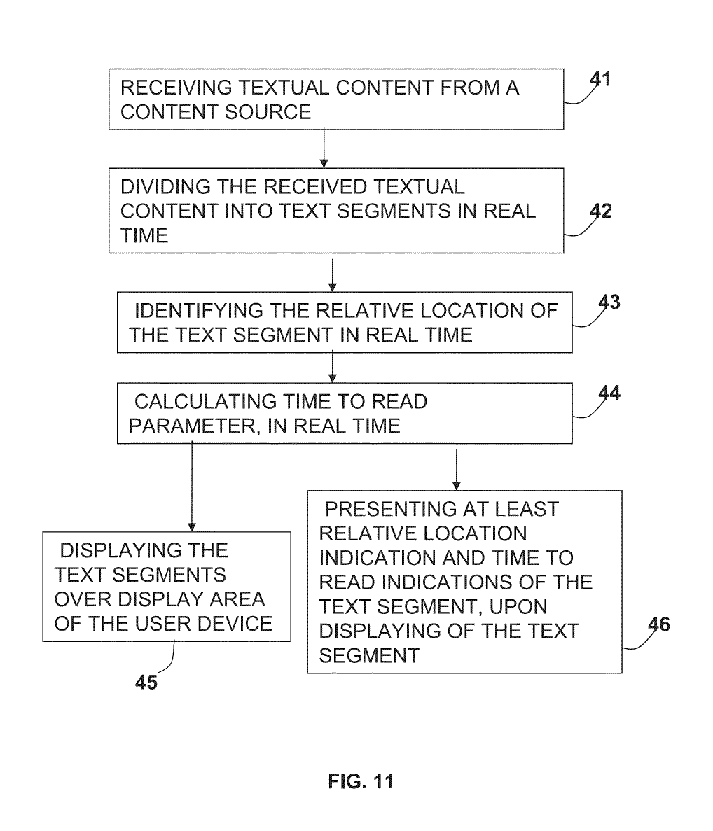

Reference is now made to FIG. 11, which is a flowchart, schematically illustrating a method of presenting content over a display area of a user device, according to some embodiments of the present invention.

The method may include receiving textual content from a content source 41 first and then dividing the received textual content into text segments, according to predefined segmentation rules 42. The segmentation rules may include the criteria for allowing a maximal total complexity rank at each segment.

Then, an identification of relative location of each text segment is carried out 43 in real time. The identification of relative locations of text segments may be carried out according to any of the optional calculations and ways previously described.

Once the relative location of a text segment is identified the time to read parameter, relating to the identified relative location, is calculated in real time 44.

The text segments may be consecutively displayed over the display area of the user device 45, using serial visual presentation thereof, and the indications relating to the identified relative location and calculated time to read parameter of each text segment may be presented over the display area substantially simultaneously to the display of the text segment 46.

According to some embodiments of the present invention, the system enables presentation of an estimated reading time of a textual content along with presentation of a representation indicative of the textual content such as a hyperlink enabling the user to link to textual content such as an online article, a website and the like, headlines or title of an online article and/or an email indication and/or an attachment indicator in an email. For example, once an email is received including textual content and/or an attachment to a document consisting of textual content, the reading time of the entire content of the email and/or the attachment may be calculated and then presented in the email presentation. Reading time estimation of the textual content of the attachment may also be presented in proximity to the attachment indication in the email page. The indication of the reading time estimation of each received email may be presented in an inbox list, which typically indicates received emails. This allows the user to view the reading time estimation of each received email before opening it.

Optionally, a designated application for calculating and presenting the time to read estimation of each email and/or each attachment may be added to an existing email service such as a plug-in application allowing users to download this additional service and adding it to an email application they are already using such as Gmail, Hotmail, Yahoo, and the like. The plug-in application may additionally allow sorting emails in the emails list according to reading time estimations thereof.

The time to read estimation of the textual content of the email, the attachment, and/or the article may be calculated according to any calculation and method such as according to a statistically updated average reading time of a word or a segment, according to complexity of words in in the content, and the like, as previously mentioned.

The central system 200 may calculate a reading time estimation for reading an entire textual content retrieved from a content source such as an email, an attachment, and/or an article. The central system 200 may divide the textual content into text segments using any one of the segmentation methods described above or receive the textual content as segmented. Once the text segments are established the central system 200 calculates a reading time estimation of the entire textual content by using any one of the calculation methods described above such as by using an average segment reading time and multiplying the average segment reading time by the total number of text segments.

In a case of a hyperlink to the textual content the user is able to view an estimated reading time of the article to which the hyperlink refers and optionally a title of the article and decide whether to link to the article or not according to the indicated information. In another case, in which a user enters a website including a plurality of articles, each article indication such as the articles' titles may be accompanied by an indication of the time to read estimation.

Additionally or alternatively, the hyperlink may refer to a first location, such as webpage, representing the reading time estimation and optionally a short review of the article to which it refers. The first location may include another hyperlink referring to the article itself allowing the user to first see a review of the related article and its estimated reading time and then link to it if he/she decides to read it. The short review may be taken from a headline, title, and/or abstract of the article, for example, which is typically represented in the HTML code thereof.

This allows the user to first view the reading time estimation of each linked textual content and only view the entire text segment by segment or as a whole piece if he/she decides to actually read it.

Optionally, the central system 200 allows calculating time to read of email textual content and/or textual content of attachments included in emails. The central system 200 may access one or more email accounts of the user, identify each received email and textual content therein and/or textual content of an attachment to the email and calculate time to read estimation of each such textual content. The serial visual presentation module 120 may then present the time to read estimation of each email and/or each attachment along with presentation thereof.

The system may allow calculating reading time estimation of any textual content and/or any part of textual content and presenting the calculated reading time estimation along with any representation of the respective textual content.

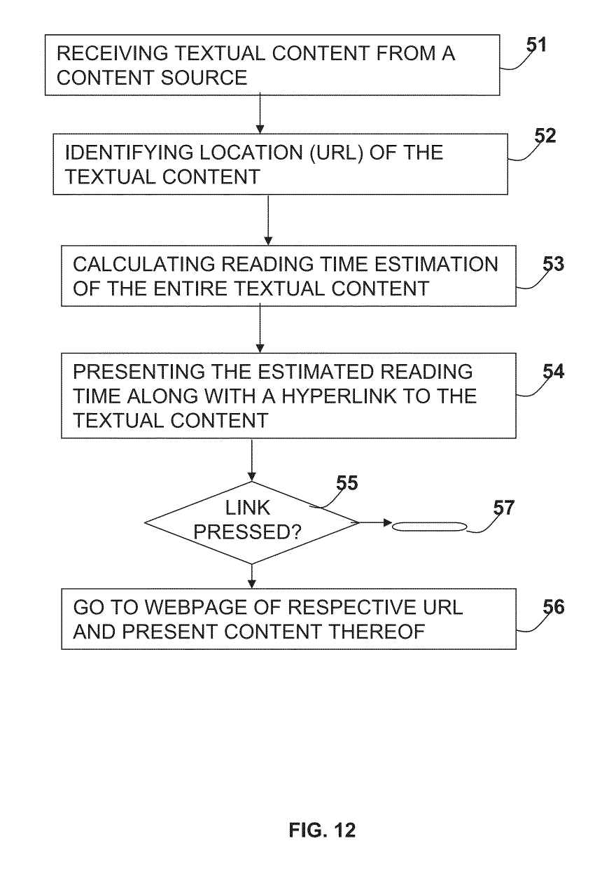

Reference is now made to FIG. 12, which is a flowchart schematically illustrating a process of presenting a hyperlink to a textual content and reading time thereof over a display area of a user device, according to some embodiments of the present invention. Once a textual content is received from a content source 51, the location of the textual content is identified 52 such as its URL address. An estimated reading time for reading the entire textual content is then calculated 53 according to any predetermined calculation technique and/or program. For example, in case of an online article, the reading time may be calculated by counting the number of words in the article, calculating the complexity rank of each word, assigning a respective time factor for each complexity rank and summing up all the time factors. Once the reading time estimation is calculated the estimated reading time is presented to the user over the display area along with the hyperlink presentation 54 allowing the user to choose whether or not he/she wishes to enter the link after viewing the estimated reading time. If the user links to the article 55, the article may be presented by linking thereto 56. If the user does not link to the article, the session is terminated and the hyperlink and reading time estimation may remain presented over the display area until the user exits the application.

Additionally or alternatively, once the user links to the article, steps 42-46 of the former described method may be executed allowing segmentation of the article and RSVP presentation of the text segments along with presentation of relative location indication.

According to some embodiments of the present invention, the system allows presenting the text segments as vibration segments by controlling a vibration module of the user device 100. The vibration module of the user device 100 may be any device that allows vibrating one or more parts of the user device 100 such as a vibration motor that is commonly used in mobile phones for allowing operating the phone in a vibration mode, using the phone speaker for actuating the vibrations therethrough.

Once the textual content is divided into text segments according to complexity, for example, the analysis module 110 may enable translating these text segments, into vibration segments, where each vibration segment represents the word or words in each segment. The vibration representing each word is translated according to a predefined vibration encoding such as tactile signing for blind and deaf people or Morse code, and the like. A pause following each vibration segment may be indicative of an end of the respective vibration segment, where the duration of each segment and/or each pause may be indicative of the relative location of each vibration segment and/or of the respective remaining reading time of the presented vibration segment. In this way the system inserts a different pause between the vibration segments each pause representing the relative location of the respective vibration segment or the remaining reading time of at least part of the textual content in relation to the relative location. This allows users who can read text by tactile sensing of vibrations according to a specific vibration encoding to use this system for reading textual content such as online articles, emails, documents, and the like, using their handheld devices.

Optionally, the central system 200 receives a specific vibration encoding selection from the user device 100 and translates the text segments into vibration segments according to the selected encoding. For example, the system enables selecting a vibration encoding out of two optional encoding methods: a Morse code encoding and a specific tactile signing encoding. Once the user selects the encoding he/she can read, the central system 200 translates the text segments to vibration segments accordingly. The vibration segments are then presented to the user in a presentation rhythmus that corresponds to the relative location and/or the respective remaining reading time of each vibration segment, by controlling the vibrating mode of the user device 100.

It is appreciated that certain features of the present invention, which are, for clarity, described in the context of separate embodiments, may also be provided in combination in a single embodiment. Conversely, various features of the present invention, which are, for brevity, described in the context of a single embodiment, may also be provided separately or in any suitable sub-combination.

Although the present invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system of presenting textual content over a display area of at least one user device, said system comprising:
an analysis module which receives a plurality of text segments of a textual content and identifies relative location of each said text segment in said textual content; and
a serial visual presentation module which consecutively displays said plurality of text segments over said display area each substantially simultaneously with at least one indication relating to a respective said relative location.

2. The system of claim 1, wherein said indication is of the relative location of each said displayed text segment.

3. The system of claim 1, wherein said analysis module calculates a remaining reading time estimation for each said text segment, said indication comprising a respective said remaining reading time estimation.

4. The system of claim 1, wherein said analysis module performs a content analysis of said textual content by identifying a complexity level of each word in said textual content, said serial visual presentation module adapts serial visual presentation of said textual content, according to said content analysis.

5. The system of claim 1, wherein said analysis module performs an environmental analysis by receiving environmental data relating to the at least one user, said serial visual presentation module adapts serial visual presentation of said textual content, according to said environmental analysis.

6. The system of claim 5, wherein said analysis module retrieves said environmental data from at least one sensor, configured to sense environmental conditions of the at least one user.

7. The system of claim 1, wherein said analysis module performs a contextual analysis of the textual content, by identifying a type of the textual content, said serial visual presentation module adapts serial visual presentation of said textual content, according to said contextual analysis.

8. The system of claim 1, further comprising a personalization module, operatively associated with said serial visual presentation module, said personalization module identifies reading pace of the at least one user, said serial visual presentation module adapts serial visual presentation of said textual content according to said identified reading pace.

9. The system of claim 8, wherein said personalization module monitors and stores information relating to reading habits of the at least one user for a predefined period for determining an average reading pace of the at least one user.

10. The system of claim 1, further comprising a navigation module associated with a storage unit, said navigation module is configured to allow a user to navigate through previously displayed text segments by using said identified relative locations and by storing and retrieving of previously displayed text segments from said storage unit.

11. The system of claim 1, further comprising a statistical module, operatively associated with said analysis module and performs a statistical analysis of reading patterns of a plurality of users, said serial visual presentation module adapts serial visual presentation of said textual content according to said statistical analysis.

12. The system of claim 1, further comprising a visuals module, operatively associated with said serial visual presentation module, said visuals module associates words in said text segments with visual effects, and said serial visual presentation module presents said associated visual effect upon displaying of a respective text segment comprising a word associated with said visual effect.

13. The system of claim 1, wherein said analysis module and said serial visual presentation module are operated by a user device, which is a handheld device.

14. The system of claim 1, wherein said analysis module retrieves additional data from an external source relating to activity of the user and analyzes said data, and wherein said serial visual presentation module adapts serial visual presentation of the text segments according to the activity of the user.

15. The system of claim 14, wherein said additional data comprises biometric parameters relating to the user activity.

16. The system of claim 1, wherein said analysis module and serial visual presentation module are installed in a designated gadget device having a display area, wherein said serial visual presentation is adapted to functionality of said gadget.

17. The system of claim 1, wherein said analysis module further enables translating each text segment of said textual content into a vibration segment according to at least one vibration encoding, and said serial visual presentation module enables presenting said vibration segments and said at least one indication relating to a respective said relative location thereof, by controlling a vibration module of said user device.

18. A method of presenting textual content over a display area of at least one user device, said method comprising:
1) receiving a plurality of text segments of textual content;
2) identifying relative location of each text segment in relation to said textual content;
3) consecutively displaying said text segments over said display area; and
4) presenting of at least one indication relating to the identified relative location of each text segment, in real time, upon displaying of a respective said text segment.

19. The method of claim 18, wherein steps 1)-4) are carried out in real time.

20. The method of claim 18, further comprising preliminary segmentation of said textual content into said text segments by dividing the textual content into text segments in advance prior to presenting of the first text segment, and wherein said relative location identification includes preliminary identification of the relative location of each of said text segments.

21. The method of claim 18, further comprising retrieving code from an online content source, extracting textual content and structural elements from said code, and dividing the textual content into said plurality of text segments according to said structural elements.

22. A system of presenting textual content over a display area of a plurality of user devices, said system comprising:
a central system, which receives textual content from at least one content source, analyzes said textual content and divides said textual content into a plurality of text segments, according to said analysis; and
a plurality of user devices each receives said plurality of text segments from said central system and consecutively displays said plurality of text segments over said display area each substantially simultaneously with at least one indication relating to a relative location thereof in said textual content.

23. A method of presenting textual content over a display area of a user device, said method comprising:
receiving textual content from a content source;
detecting pupil movements of a user watching a serial visual presentation of a plurality of textual segments of said textual content;
determining emotional reaction of the user to each said textual segment by identifying at least one pupil movement;
assigning a complexity level to each said textual segment according to a respective said at least one pupil movement; and
adapting another serial visual presentation of at least some of said plurality of text segments each according to a respective said assigned complexity level.

24. The method of claim 23, wherein said at least one pupil movement is indicative of a focus level.

25. A system of presenting textual content over a display area of a handheld user device, said system comprising:
at least one sensor for reading at least one environmental parameter in proximity to a user using the handheld user device;
an analysis module which receives a plurality of text segments of a textual content; and
a serial visual presentation module which adapts serial visual presentation of said plurality of text segments according to said at least one environmental parameter.

26. A method of presenting textual content over a display area of a user device, said method comprising:
calculating an estimated reading time for reading said textual content; and
presenting said estimated reading time upon presentation of a representation indicative of said textual content, over said display area, so as to allow a user of said user device to view said estimated reading time prior to reading said textual content.
